(19) United States
(12) Patent Application Publication
(10) Pub. No.: US 2014/0090366 A1
(43) Pub. Date: Apr. 3, 2014

(54) Generator

(71) Applicant: Ahsan Akbar, Chicago, IL (US)

(72) Inventor: Ahsan Akbar, Chicago, IL (US)

(21) Appl. No.: 14/043,815

(22) Filed: Oct. 1, 2013

Related U.S. Application Data
(60) Provisional application No. 61/708,053, filed on Oct. 1, 2012.
(60) Provisional application No. 61/718,004, filed on Oct. 24, 2012.
(60) Provisional application No. 61/759,272, filed on Jan. 31, 2013.
(60) Provisional application No. 61/764,399, filed on Feb. 13, 2013.
(60) Provisional application No. 61/868,857, filed on Aug. 22, 2013.

(51) Int. Cl. F03D 9/00

(52) U.S. Cl. CPC F03D 9/002
USPC 60/398

(57) ABSTRACT

A generator includes: a housing defining a chamber; a fan in fluid communication with the chamber, wherein the fan is oriented to draw a partial vacuum in the chamber; a pipe including a first opening and a second opening, wherein the first opening is in fluid communication with the chamber and the second opening is in fluid communication with the ambient atmosphere, such that when a partial vacuum is drawn in the chamber a partial vacuum is drawn within the pipe; a plurality of turbine blades within the pipe configured such that airflow from the second opening towards the first opening flows across the plurality of turbine blades to cause the turbine blades to rotate; a rotating element driven into rotational movement by the rotation of the turbine blades; and an electro-magnetic generator configured such that the rotating pipe is a rotating element within the electro-magnetic generator.

### CROSS-REFERENCE TO RELATED APPLICATIONS

This application claims the benefit of U.S. Provisional Application No. 61/708,053, filed on Oct. 1, 2012, U.S. Provisional Application No. 61/718,004, filed on Oct. 24, 2012, U.S. Provisional Application No. 61/759,272, filed on Jan. 1, 2013, U.S. Provisional Application No. 61/764,399, filed on Feb. 13, 2013, and U.S. Provisional Application No. 61/868,857, filed on Aug. 22, 2013, the entirety of each is incorporated herein by reference.

### TECHNICAL FIELD OF THE INVENTION

The present invention relates to the general field of power generating systems and more particularly to an air driven apparatus that develops a power generator using an artificially created confined vortex or whirling mass of air in the form of a rotating column. More specifically the invention relates to a system and method of developing energy from a source of airflow. In part, the system includes a powerful fan that removes air from the system. The air that is removed from the system is replaced from the atmosphere (in an equal, but opposite reaction) through a rotating pipe including a series of spaced cones/vanes affixed thereto. In some embodiments, additional pipes are arranged to draw air and jet the air out for generating rotating and swirling air conditions within the revolving pipe thus resulting in a low pressure region and vortex conditions.

### BACKGROUND OF THE INVENTION

Power plants of the vortex-creating type are known, such as for example U.S. Pat. No. 7,364,399 issued to Stiig et al. and U.S. Pat. No. 4,070,131 issued to Yeh. Power generating systems such as Stiig and Yeh include free standing relatively huge vertical towers wherein the tower is open at the top and includes inlet for wind generating a cyclone in the tower and a turbine that has inlets through the base and an outlet to the center of the cyclone in the tower that drives a generator. The low-pressure region in the center of the cyclone generates the driving power for the airflow through the turbine. Such units as disclosed in Stiig essentially comprise a complete plant. As noted, the Stiig and Yeh patents include essentially large areas and multiple components including hydraulic motors and pumps, and heating elements all of which interact to develop a cyclonic formation to enhance wind power. In total the Stiig and Yeh concepts are quite huge, complex, expensive and are generally not suitable for general commercial units. In contrast, the present invention is directed to power systems for that may be used in transportation systems as well as stand alone power generation

Accordingly, there is a need for power systems for that may be used in transportation systems as well as stand alone power generation, as described herein.

### BRIEF SUMMARY OF THE INVENTION

To meet the needs described above and others, the present disclosure provides power systems for that may be used in transportation systems as well as stand-alone power generation. The following disclosure discloses several examples of a generator, but it is understood that there are numerous ways to implement the generator to accomplish the advantages disclosed herein and the following examples are provided for illustrative purposes of the disclosed solutions. Further, while described throughout the disclosure as a generator, the solutions provided herein may be embodied in a motor, generator motor, generator, etc., and the terms may be used interchangeably.

In an example of a generator, the generator includes an exhaust fan adapted to draw a partial vacuum in a chamber. After a partial vacuum is drawn within the chamber, air may flow into the generator through a rotating turbine pipe, which forms the rotational element of an electro-magnetic generator. Rotation of the turbine pipe is caused by the airflow through the turbine pipe interacting with a series of turbine blades located within the turbine pipe. The inflowing air is drawn across the turbine blades creating a whirling mass of airflow, which causes the rotation of the turbine pipe. The turbine pipe may be supported by a series of supports that enable the turbine pipe to freely rotate within the generator.

A forward fan may be provided to accelerate air into the generator from another system disposed in front of the generator. The forward fan may be surrounded by a forward bypass tube that creates a bypass for some of the air to pass around the forward fan similar to a bypass used in a jet engine. Although only some of the fans described in this disclosure have a bypass, it is contemplated that any powered fan may include a bypass or omit the bypass as will be understood by one of ordinary skill in the art. The forward fan and exhaust fan may permit the generator to be chained with other generators or further systems.

In use, the partial vacuum in the chamber (relative low-pressure zone) causes airflow from the atmosphere (relative high-pressure zone) or other systems through the turbine pipe, consequently generating power in the generator, by drawing an equal and opposite quantity of air as the quantity that has been drawn from the chamber by the exhaust fan. In some sense, the generator uses air as a fuel source, which provides electricity generation from an abundant, zero-emission source.

The exhaust fan, and all other powered fans described herein, such as the forward fan, may take many forms as appropriate for the design of the generator. For example, in some embodiments, the exhaust fan may be a jet engine. In others, the exhaust fan may be a high velocity fan. Those skilled in the art will appreciate the range of fans that may be implemented in the generator based on the disclosures provided herein. However, for the purpose of illustration, powered fans in this disclosure are generally described as electric fans.

It is understood that embodiments of the generator without a separate chamber may be implemented or that alternate chambers of varied size, shape, and design may be incorporated into the generator. Accordingly, varied forms of the generator may be mobile or stationary, as suited to the specific application as illustrated in the further examples provided. Moreover, it is understood that the main function of the chamber is to mate the exhaust fan with the turbine pipe. Accordingly, some embodiments of the generator may include a minimal chamber or, in instances in which the exhaust fan and turbine pipe are integrated, no chamber at all.

As will be described further below, the turbine pipe is a magnetic, hollow, pipe. As noted, a series of turbine blades may be spaced along the length of the turbine pipe. In some embodiments, there are nine turbine blades; however, the number and configuration of the turbine blades may be adapted to suit the particular embodiment of the generator. For example, depending on the speed and volume of the air flowing through the turbine pipe, the number of turbine blades may be increased or decreased. Further, the dimensions of the turbine pipe may be varied. In other examples, the length of the turbine pipe may be significantly longer. In some contemplated examples, the turbine pipe may be miles long. Such embodiments may benefit from including a much greater number of turbine blades.

As described above, the turbine pipe is magnetic and forms the rotational element of an electro-magnetic generator. Generator coils may surround the turbine pipe and may generate electricity using the rotational movement of the rotating turbine pipe, as will be understood by one of ordinary skill in the art.

The supports include a simple bracing structure that holds the turbine pipe in place and enables it to freely spin on its longitudinal axis. As such, the supports may include a plurality of bearings supporting the turbine pipe around its perimeter. As an example, a turbine pipe may be held by two supports, however, depending on the specific implementation, there may be any number of supports of any form.

As noted above, a forward fan and an exhaust fan direct airflow into or out of the generator. The forward fan and exhaust fan may further be used to regulate the airflow into and out of the generator. In other embodiments, other mechanisms may control or direct airflow into the generator, such as a nozzle, valve, damper, etc. Further, the location of the airflow regulating mechanism may be varied. For example, an airflow regulating mechanism may be located at the opposite end of the rotating turbine pipe, near the chamber.

In another embodiment of a generator, the generator may include an exhaust fan adapted to draw a partial vacuum in a chamber. After a partial vacuum is drawn within the chamber, air may flow into the generator through a turbine pipe, which is held fixed in contrast to the rotating turbine pipe of the previously described generator. The turbine pipe may be contained within a wind tunnel. A forward fan may draw air into the generator.

As air flows through the turbine pipe, it interacts with a series of turbine blades located within the turbine pipe. The inflowing air is drawn across the turbine blades creating a whirling mass of airflow. The fan blades are mounted on a main shaft. A turbine pipe electric motor fan may be provided to further accelerate the air within the turbine pipe. The turbine pipe electric motor fan may be mounted on the main shaft but may have bearings to permit it to rotate independently when powered. A turbine pipe bypass tube may surround the turbine pipe electric motor fan to create a bypass around the turbine pipe electric motor fan. The fan blades turn the main shaft that, in turn, drives an electric generator. Air then flows out of the turbine pipe into the chamber and out either the rear bypass or the exhaust fan.

A turbine pipe may be supported by a series of supports that enable the turbine pipe to freely rotate within the generator. An exhaust fan may be provided to funnel air out of the generator into another system. The exhaust fan permits the generator to be chained with other generators, or further systems.

A turbine pipes may include continuous channels located along approximately the entire length of the internal diameter of the turbine pipe. In one contemplated example, the interior diameter of the rotating turbine pipe may be approximately sixteen inches and the depth of the continuous channel may be approximately three to five inches deep, though it is understood the proportions and geometry may vary to suit a particular application.

In use, as airflows through the rotating turbine pipe, the channel creates a vortex in the interior of the turbine pipe. The friction of the air flowing through the turbine pipe causes the turbine pipe to rotate, thereby creating useful energy in the electro-magnetic generator. The tornado action created by the vortex further assists in turning the turbine pipe.

In another embodiment, a generator may be used as the vehicle power plant of an automobile. In an embodiment of the automobile, electric motor fans pulls the air into rear wind tunnels. The rear wind tunnels may be constructed from turbine pipes. As air passes through the rear wind tunnels, it turns fan blades. The fan blades may be mounted on main shafts. The fan blades may turn the main shafts to provide power to wheels. The main shafts may also be used to drive electric generators.

After flowing through the rear wind tunnels, the air may be drawn into a primary wind tunnel by a primary wind tunnel electric fan. The primary wind tunnel may include wind sails. As the air passes over the wind sails, it may impart forward energy. An electric motor fan in the middle of the primary wind tunnel may further accelerate the airflow across the wind sails. After passing over the wind sails, the air may pass into forward wind tunnels.

The forward wind tunnels may be constructed from turbine pipes. Like the rear wind tunnels, the forward wind tunnels may include fan blades mounted on main shafts to provide power to wheels and/or to drive electric generators. A forward fan may be used to pull air out of the forward wind tunnels and into forward outflow pipes. The forward outflow pipes may also be turbine pipes.

In another embodiment, a generator may be used as the vehicle power plant of a train. The generator in the train is substantially the same as the generator powering the automobile thus showing the versatility of the generator.

In an additional embodiment, a generator may be used as the vehicle power plant of a ship. An electric motor fan pulls the air into rear wind tunnels. As air passes through the rear wind tunnels, it turns fan blades. The fan blades may be mounted on main shafts. The fan blades may turn the main shafts to power a propeller or to drive electric generators. After flowing through the rear wind tunnels, the air may be drawn into a primary wind tunnel by a primary wind tunnel electric fan. The primary wind tunnel may include wind sails. As the air passes over the wind sails, it may impart forward energy to the wind sails before passing into forward wind tunnels. An electric motor fan in the middle of the primary wind tunnel may further accelerate the airflow across the wind sails. The forward wind tunnels may include fan blades mounted on main shafts to provide power to a propeller and/or to drive electric generators. A forward fan may be used to pull air out of the forward wind tunnels and into forward outflow pipes. The rear wind tunnels, forward wind tunnels, and forward outflow pipes may be turbine pipes.

In a further embodiment, a generator may be used as the vehicle power plant of an aircraft. Electric motor fans pull air into rear wind tunnels of the aircraft. The rear wind tunnels may be turbine pipes. The air flowing through the rear wind tunnels turns fan blades. The fan blades are mounted on main shafts in the rear wind tunnel. The fan blades turn the main shafts that, in turn, drive electric generators.

A primary electric fan then draws the air out of the rear wind tunnel and into a primary wind tunnel. The primary wind tunnel may include wind sails. As the air passes over the wind sails, it may impart forward energy to the wind sails to create thrust before passing into exhaust wind tunnels. An electric motor fan in the middle of the primary wind tunnel may further accelerate the airflow across the wind sails. The exhaust wind tunnels may be turbine pipes. The exhaust wind tunnels may include rotatable nozzles along its length. Air may flow out of the rotatable nozzles to provide additionally lift. The remaining air may be forced out rear exhausts by rear exhaust fans. The aircraft may further include movable wind sails along the outer surface of the aircraft that may be extended to act as brakes for slowing or stopping the aircraft.

In yet another embodiment, a generator may be used as the power plant of a rocket. Electric motor fans pull air into rear wind tunnels of the rocket. As air passes through the rear wind tunnels, it turns fan blades. The fan blades may be mounted on main shafts. The fan blades may turn the main shafts to drive electric generators. After flowing through the rear wind tunnels, the air may be drawn into a primary wind tunnel by a primary wind tunnel electric fan. The primary wind tunnel may include wind sails. An electric motor fan in the middle of the primary wind tunnel may further accelerate the airflow across the wind sails. As the air passes over the wind sails, it may impart upward energy to the wind sails. A forward fan may be used to pull air out of the forward wind tunnels and into forward outflow pipes. As the air flows out the forward outflow pipes, it may impart further upward or forward momentum on the rocket. The rear wind tunnels, and forward outflow pipes may be turbine pipes.

In another example of a rocket using an example of a generator as the vehicle power plant, the rocket may include exhaust wind tunnels rather than forward outflow pipes. Like the other rocket, electric motor fans pull air into rear wind tunnels. The rear wind tunnels may be turbine pipes. The air flowing through the rear wind tunnels turns fan blades. The fan blades are mounted on main shafts in the rear wind tunnel. The fan blades turn the main shafts that, in turn, drive electric generators.

A primary electric fan then draws the air out of the rear wind tunnel and into a primary wind tunnel. The primary wind tunnel may include wind sails. An electric motor fan in the middle of the primary wind tunnel may further accelerate the airflow across the wind sails. As the air passes over the wind sails, it may impart forward energy to the wind sails to create thrust before passing into exhaust wind tunnels. The exhaust wind tunnels may be turbine pipes. The exhaust wind tunnels may wrap around the interior of the rocket to funnel the air out of the rear exhausts at the base of the rocket. Air may be forced out a rear exhaust by a rear exhaust fan. An advantage of the invention is that it provides a power generator that minimizes fuel consumption.

Another advantage of the invention is that it provides a power generator that is mobile and may be used with various transportation systems.

A further advantage of the invention is that it provides a power generator that exploits the vortex properties of air to increase power generation efficiency.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic side view of an example of a generator.

FIG. 2 is a schematic side view of another example of a generator.

FIG. 3 is a perspective view of a rotating turbine pipe.

FIG. 4 is a perspective view of an example automobile including a generator.

FIG. 5 is a perspective view of an example train including a generator.

FIG. 6 is a perspective view of an example boat including a generator.

FIG. 7 is a perspective view of an example aircraft including a generator.

FIG. 8 is a perspective view of an example rocket including a generator.

FIG. 9 is a perspective view of another example rocket including a generator.

### DETAILED DESCRIPTION OF THE INVENTION

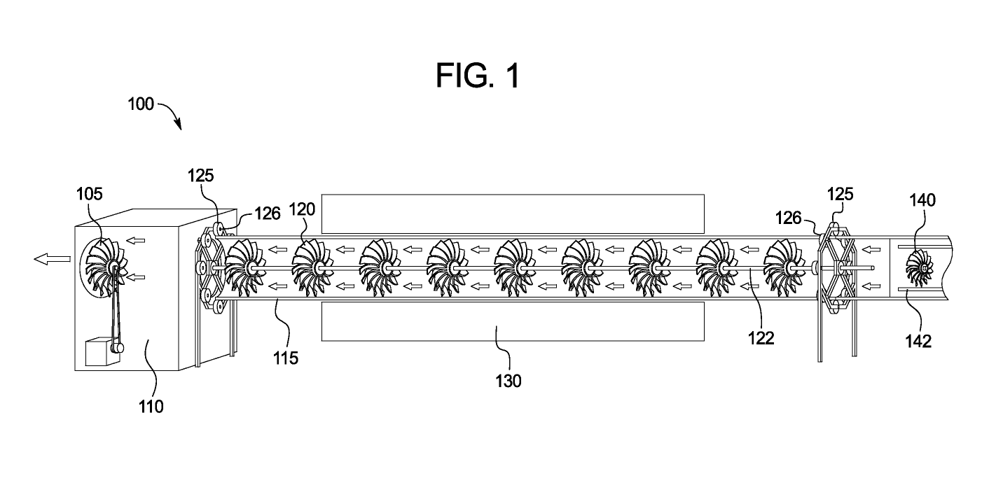

FIG. 1 illustrates a schematic side view of an example of a generator 100 according to the presently disclosed subject matter. It is understood that there are numerous ways to implement the generator 100 to accomplish the advantages disclosed herein and the following examples are provided for illustrative purposes of the disclosed solutions.

As shown in FIG. 1, the example of the generator 100 shown includes an exhaust fan 105 adapted to draw a partial vacuum in a chamber 110. After a partial vacuum is drawn within the chamber 110, air may flow into the generator 100 through a rotating turbine pipe 115, which forms the rotational element of an electro-magnetic generator. Rotation of the turbine pipe 115 is caused by the airflow through the turbine pipe 115 interacting with a series of turbine blades 120 located within the turbine pipe 115. The inflowing air is drawn across the turbine blades 120 creating a whirling mass of airflow, which causes the rotation of the turbine pipe 115. In the example shown in FIG. 1, the turbine pipe 115 is supported by a series of supports 125 that enable the turbine pipe 115 to freely rotate within the generator 100.

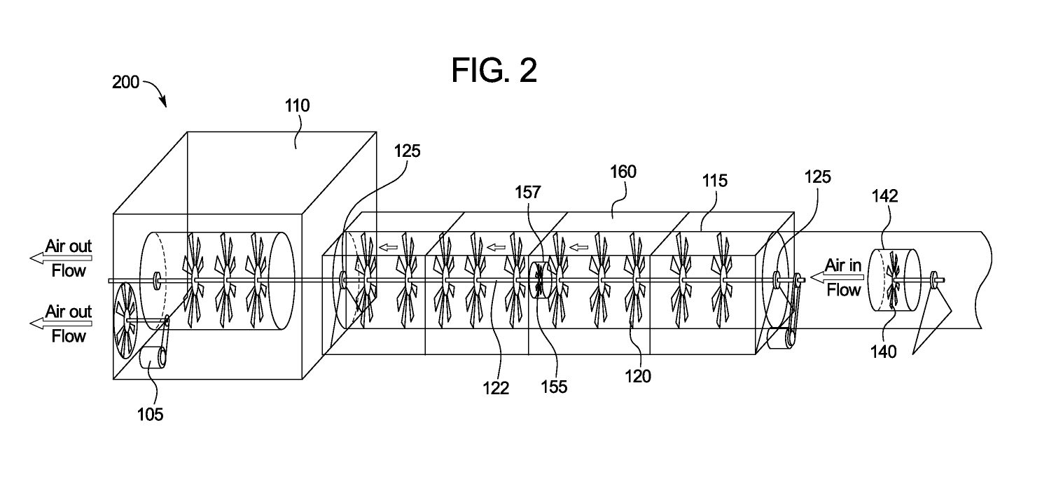

A forward fan 140 may be provided to accelerate air into the generator 100 from another system disposed in front of the generator 100. The forward fan 140 may be surrounded by a forward bypass tube 142 that creates a bypass for some of the air to pass around the forward fan 140 similar to a bypass used in a jet engine. Although only some of the fans in the embodiments shown in this disclosure have a bypass, it is contemplated that any powered fan may include a bypass or omit the bypass as will be understood by one of ordinary skill in the art. A bypass improves the efficiency of the generator 100, and all bypasses in the system may include a free spinning fan driven by a motor and duct work for the bypass between the free spinning fan and the surrounding wind tunnel. The forward fan 140 and exhaust fan 105 may permit the generator 100 to be chained with other generators 100, generators 200 (FIG. 2) or further systems.

In use, the partial vacuum in the chamber 110 (relative low-pressure zone) causes airflow from the atmosphere (relative high-pressure zone) or other systems through the turbine pipe 115, consequently generating power in the generator 100, by drawing an equal and opposite quantity of air as the quantity that has been drawn from the chamber by the exhaust fan 105. In some sense, the generator 100 uses air as a fuel source, which provides electricity generation from an abundant, zero-emission source.

The exhaust fan 105, and all other powered fans described herein, such as the forward fan 140, may take many forms as appropriate for the design of the generator 100. For example, in some embodiments, the exhaust fan 105 may be a jet engine. In others, the exhaust fan 105 may be a high velocity fan. Those skilled in the art will appreciate the range of fans that may be implemented in the generator based on the disclosures provided herein. However, for the purpose of illustration, powered fans in this disclosure are generally described as electric fans.

It is understood that embodiments of the generator 100 without a separate chamber 110 may be implemented or that alternate chambers 110 of varied size, shape, and design may be incorporated into the generator 100. Accordingly, varied forms of the generator 100 may be mobile or stationary, as suited to the specific application as illustrated in the further examples provided. Moreover, it is understood that the main function of the chamber 105 is to mate the exhaust fan with the turbine pipe 115. Accordingly, some embodiments of the generator 100 may include a minimal chamber 110 or, in instances in which the exhaust fan 105 and turbine pipe 115 are integrated, no chamber at all.

As will be described further below, the turbine pipe 115 shown in FIG. 1 is a magnetic, hollow, pipe. As noted, a series of turbine blades 120 may be spaced along the length of the turbine pipe 115. In the example shown, there are nine turbine blades 120; however, the number and configuration of the turbine blades 120 may be adapted to suit the particular embodiment of the generator 100. For example, depending on the speed and volume of the air flowing through the turbine pipe 115, the number of turbine blades 120 may be increased or decreased. Further, the dimensions of the turbine pipe 115 may be varied. In other examples, the length of the turbine pipe 115 may be significantly longer. In some contemplated examples, the turbine pipe 115 may be miles long. Such embodiments may benefit from including a much greater number of turbine blades 120.

As described above, the turbine pipe 115 is magnetic and forms the rotational element of an electro-magnetic generator. Generator coils 130 may surround the turbine pipe 115 and may generate electricity using the rotational movement of the rotating turbine pipe 115, as will be understood by one of ordinary skill in the art.

The supports 125 shown in FIG. 1 include a simple bracing structure that holds the turbine pipe 115 in place and enables it to freely spin on its longitudinal axis. As such, the supports 125 may include a plurality of bearings 126 supporting the turbine pipe 115 around its perimeter. The example shown includes two supports 125, however, depending on the specific implementation, there may be any number of supports 125 of any form.

As noted above, a forward fan 140 and an exhaust fan 105 direct airflow into or out of the generator 100. The forward fan 140 and exhaust fan 105 may further be used to regulate the airflow into and out of the generator 100. In other embodiments, other mechanisms may control or direct airflow into the generator 100, such as a nozzle, valve, damper, etc. Further, the location of the airflow regulating mechanism may be varied. For example, an airflow regulating mechanism may be located at the opposite end of the rotating turbine pipe 115, near the chamber 110.

FIG. 2 illustrates another example of a generator 200. As shown in FIG. 1, the example of the generator 200 shown includes an exhaust fan 105 adapted to draw a partial vacuum in a chamber 110. After a partial vacuum is drawn within the chamber 110, air may flow into the generator 200 through a turbine pipe 115, which is held fixed in contrast to the rotating turbine pipe 115 of generator 200 in FIG. 1. The turbine pipe 115 may be contained within a wind tunnel 160. A forward fan 140 may draw air into the generator 200.

As air flows through the turbine pipe 115, it interacts with a series of turbine blades 120 located within the turbine pipe 115. The inflowing air is drawn across the turbine blades 120 creating a whirling mass of airflow. The fan blades 120 are mounted on a main shaft 122. A turbine pipe electric motor fan 155 may be provided to further accelerate the air within the turbine pipe 115. The turbine pipe electric motor fan 155 may be mounted on the main shaft 122 but may have bearings to permit it to rotate independently when powered. A turbine pipe bypass tube 157 may surround the turbine pipe electric motor fan 155 to create a bypass around the turbine pipe electric motor fan 155. The fan blades 120 turn the main shaft 122 that, in turn, drives an electric generator 170. Air then flows out of the turbine pipe 115 into the chamber 110 and out either the rear bypass 145 or the exhaust fan 105.

In the example shown in FIG. 2, the turbine pipe 115 is supported by a series of supports 125 that enable the turbine pipe 115 to freely rotate within the generator 200. The exhaust fan 105 may be provided to funnel air out of the generator 200 into another system. The exhaust fan 105 permits the generator 100 to be chained with other generators 100, generator 200, or further systems.

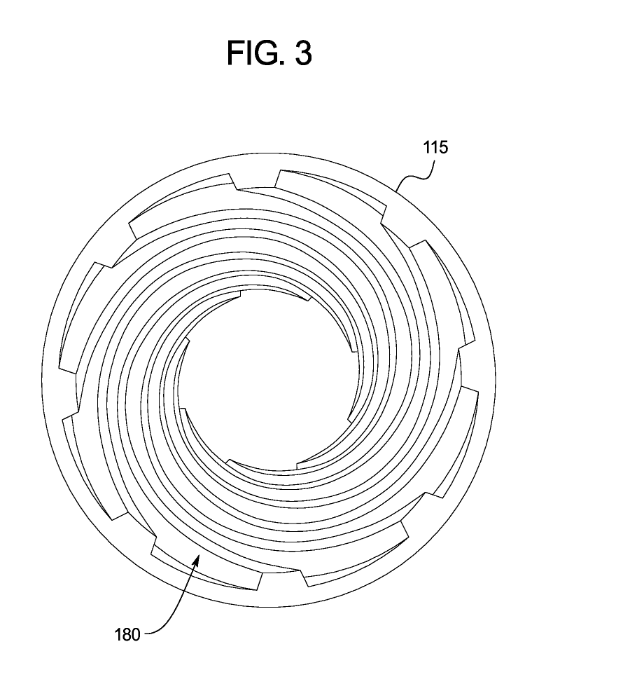

The examples of the turbine pipes 115 shown in FIGS. 1 and 2 include continuous channels located along approximately the entire length of the internal diameter of the turbine pipe 115. Another view of the continuous channel 180 within the turbine pipe 115 is shown in FIG. 3. In one contemplated example, the interior diameter of the rotating turbine pipe may be approximately sixteen inches and the depth of the continuous channel 180 may be approximately three to five inches deep, though it is understood the proportions and geometry may vary to suit a particular application.

In use, as air flows through the rotating turbine pipe 115, the channel 180 creates a vortex in the interior of the turbine pipe 115. The friction of the air flowing through the turbine pipe 115 causes the turbine pipe to rotate, thereby creating useful energy in the electro-magnetic generator. The tornado action created by the vortex further assists in turning the turbine pipe 115. Alternatively, or in addition, the tornado action may drive the rotation of the turbine blades.

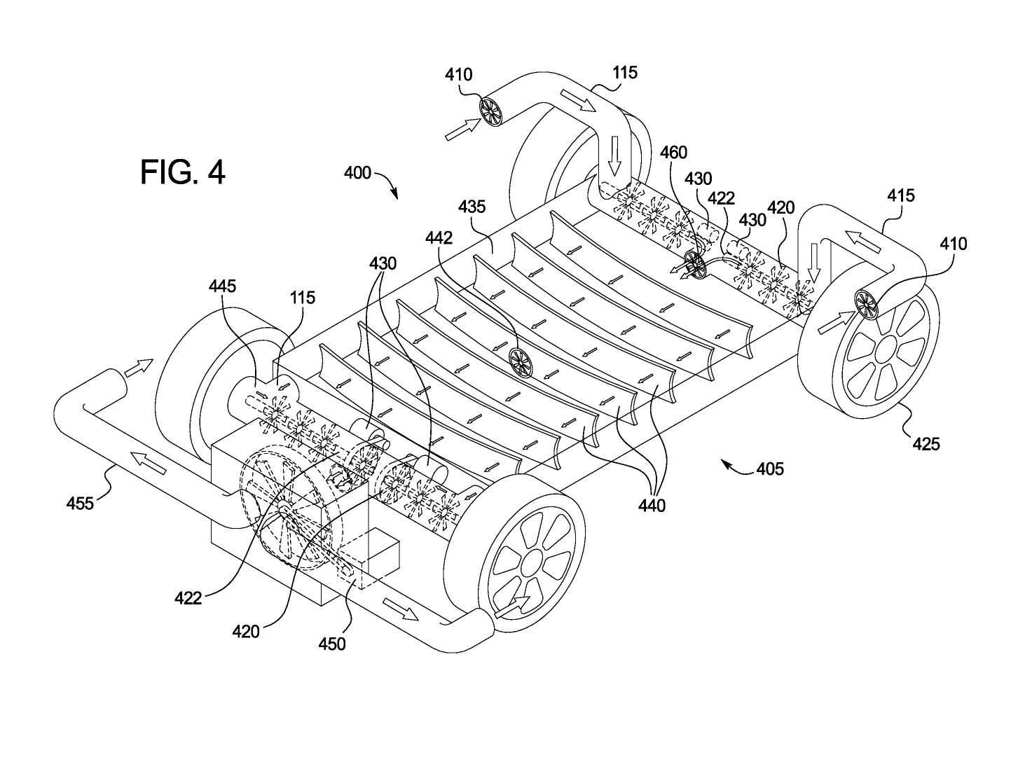

FIG. 4 illustrates an example automobile 400 using an example of a generator 405 as the vehicle power plant. Electric motor fans 410 pulls the air into rear wind tunnels 415. The rear wind tunnels 415 may be constructed from turbine pipes 115. As air passes through the rear wind tunnels 415, it turns fan blades 420. The fan blades 420 may be mounted on main shafts 422. The fan blades 420 may turn the main shafts 422 to provide power to wheels 425. The main shafts 422 may also be used to drive electric generators 430.

After flowing through the rear wind tunnels 415, the air may be drawn into a primary wind tunnel 435 by a primary wind tunnel electric fan 460. The primary wind tunnel 435 may include wind sails 440. As the air passes over the wind sails 440, it may impart forward energy. An electric motor fan 442 in the middle of the primary wind tunnel 435 may further accelerate the airflow across the wind sails 440. After passing over the wind sails 440, the air may pass into forward wind tunnels 445.

The forward wind tunnels 445 may be constructed from turbine pipes 115. Like the rear wind tunnels 415, the forward wind tunnels 445 may include fan blades 420 mounted on main shafts 422 to provide power to wheels 425 and/or to drive electric generators 430. A forward fan 450 may be used to pull air out of the forward wind tunnels 445 and into forward outflow pipes 455. The forward outflow pipes 445 may also be turbine pipes 115.

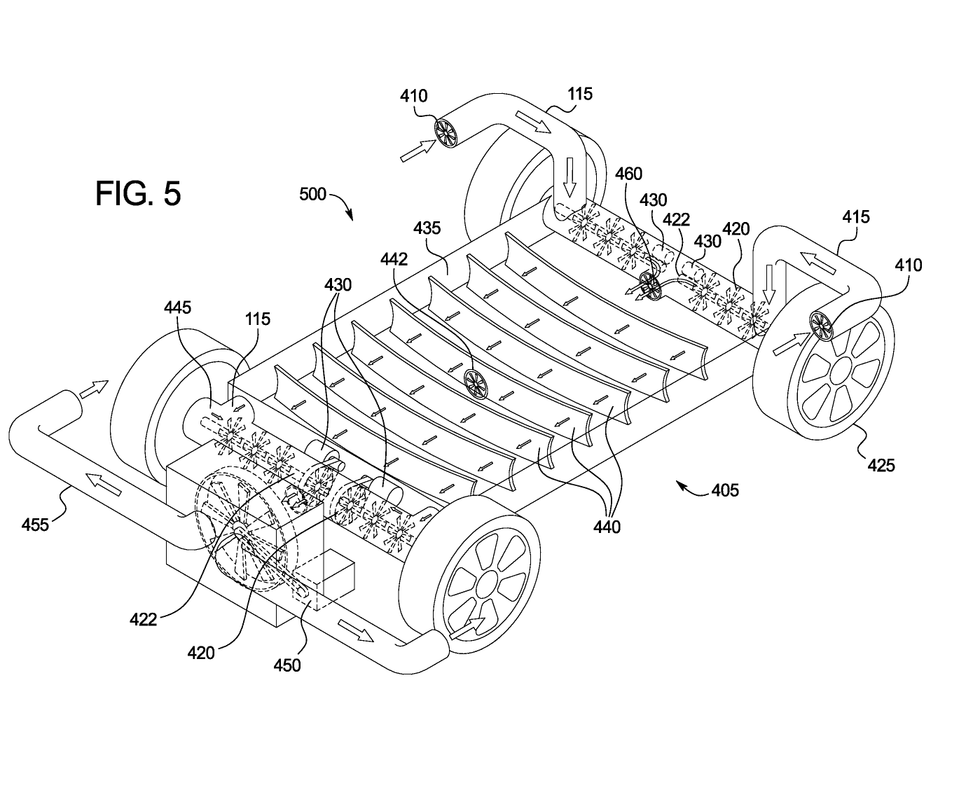

FIG. 5 illustrates an example train 500 using an example of a generator 405 as the vehicle power plant. The generator 405 shown in FIG. 5 is substantially the same as the generator 405 powering the automobile 400 thus showing the versatility of the generator 405.

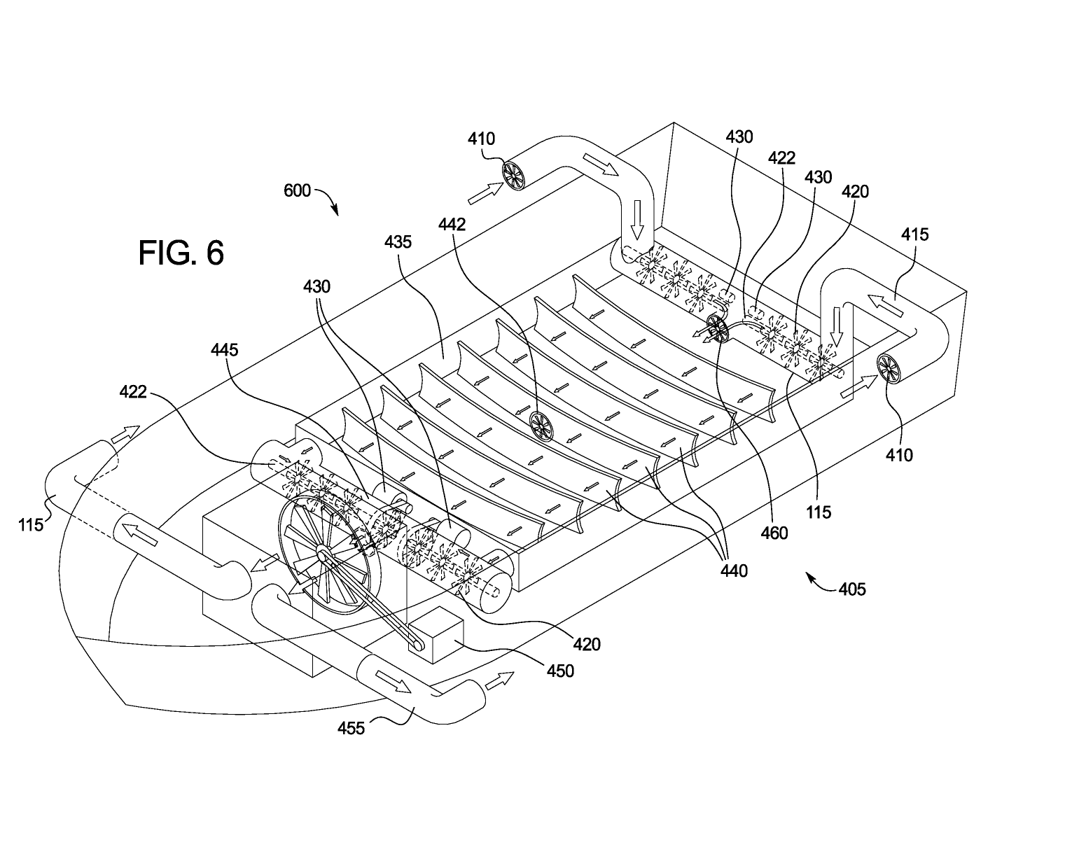

FIG. 6 illustrates an example ship 600 using an example of a generator 405 as the vehicle power plant. An electric motor fan 410 pulls the air into rear wind tunnels 415. As air passes through the rear wind tunnels 415, it turns fan blades 420. The fan blades 420 may be mounted on main shafts 422. The fan blades 420 may turn the main shafts 422 to power a propeller or to drive electric generators 430. After flowing through the rear wind tunnels 415, the air may be drawn into a primary wind tunnel 435 by a primary wind tunnel electric fan 460. The primary wind tunnel 435 may include wind sails 440. As the air passes over the wind sails 440, it may impart forward energy to the wind sails 440 before passing into forward wind tunnels 445. An electric motor fan 442 in the middle of the primary wind tunnel 435 may further accelerate the airflow across the wind sails 440. The forward wind tunnels 445 may include fan blades 420 mounted on main shafts 422 to provide power to a propeller and/or to drive electric generators 430. A forward fan 450 may be used to pull air out of the forward wind tunnels 445 and into forward outflow pipes 455. The rear wind tunnels 415, forward wind tunnels 445, and forward outflow pipes 455 may be turbine pipes 115.

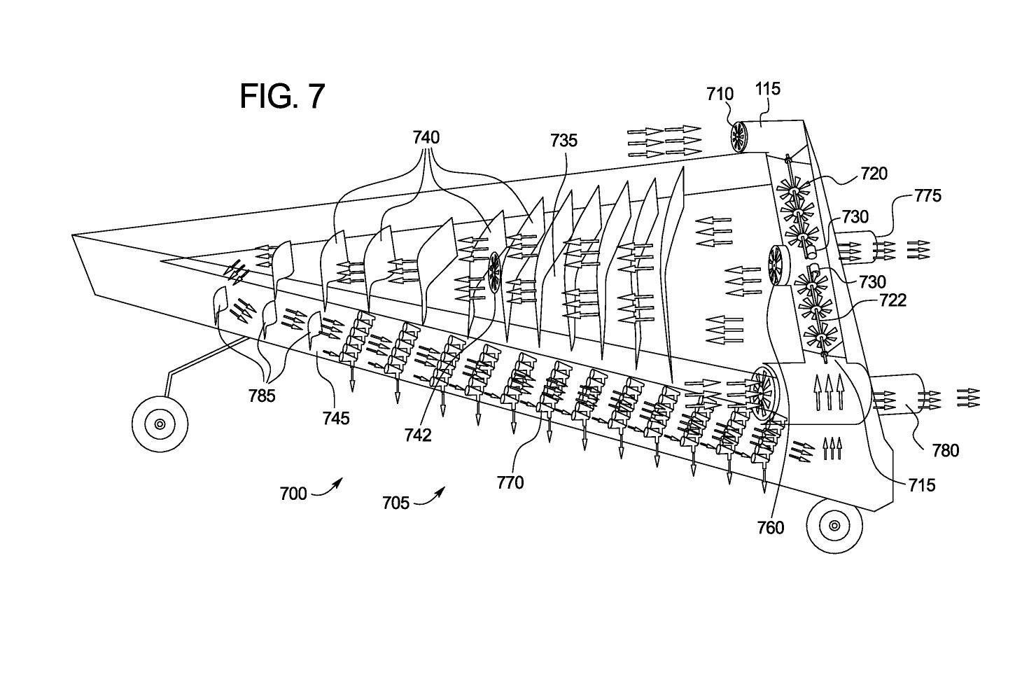

FIG. 7 illustrates an example aircraft 700 using an example of a generator 705 as the vehicle power plant. Electric motor fans 710 pull air into rear wind tunnels 715. The rear wind tunnels 715 may be turbine pipes 115. The air flowing through the rear wind tunnels 715 turns fan blades 720. The fan blades 720 are mounted on main shafts 722 in the rear wind tunnel 715. The fan blades 720 turn the main shafts 722 that, in turn, drive electric generators 730.

A primary electric fan 760 then draws the air out of the rear wind tunnel 715 and into a primary wind tunnel 735. The primary wind tunnel 735 may include wind sails 740. As the air passes over the wind sails 740, it may impart forward energy to the wind sails 740 to create thrust before passing into exhaust wind tunnels 745. An electric motor fan 742 in the middle of the primary wind tunnel 735 may further accelerate the airflow across the wind sails 740. The exhaust wind tunnels 745 may be turbine pipes 115. The exhaust wind tunnels 745 may include rotatable nozzles 770 along its length. Air may flow out of the rotatable nozzles 770 to provide additionally lift. The remaining air may be forced out rear exhausts 775 by rear exhaust fans 780. The aircraft 700 may further include movable wind sails 785 along the inner surface of the exhaust wind tunnels 745 that may be extended to act as brakes for slowing or stopping the aircraft 700.

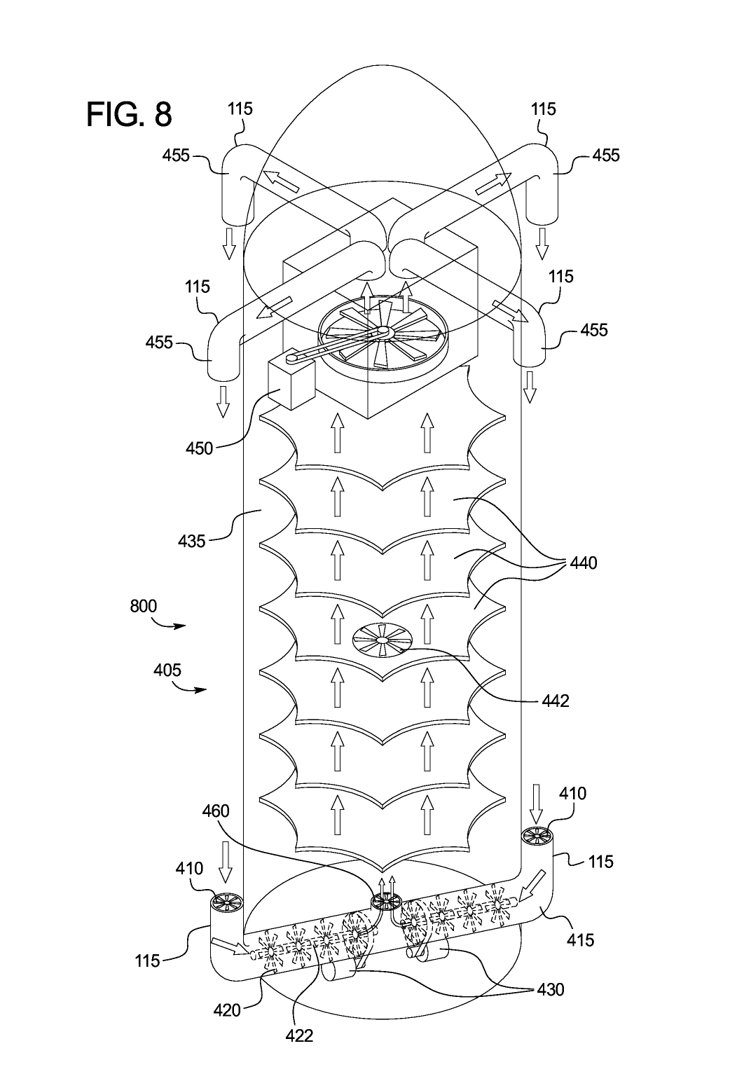

FIG. 8 illustrates an example rocket 800 using an example of a generator 405 as the rocket power plant. Electric motor fans 410 pull air into rear wind tunnels 415. As air passes through the rear wind tunnels 415, it turns fan blades 420. The fan blades 420 may be mounted on main shafts 422. The fan blades 420 may turn the main shafts 422 to drive electric generators 430. After flowing through the rear wind tunnels 415, the air may be drawn into a primary wind tunnel 435 by a primary wind tunnel electric fan 460. The primary wind tunnel 435 may include wind sails 440. An electric motor fan 442 in the middle of the primary wind tunnel 435 may further accelerate the airflow across the wind sails 440. As the air passes over the wind sails 440, it may impart upward energy to the wind sails 440. A forward fan 450 may be used to pull air out of the forward wind tunnels 445 and into forward outflow pipes 455. As the air flows out the forward outflow pipes 455, it may impart further upward or forward momentum on the rocket 800. The rear wind tunnels 415, and forward outflow pipes 455 may be turbine pipes 115.

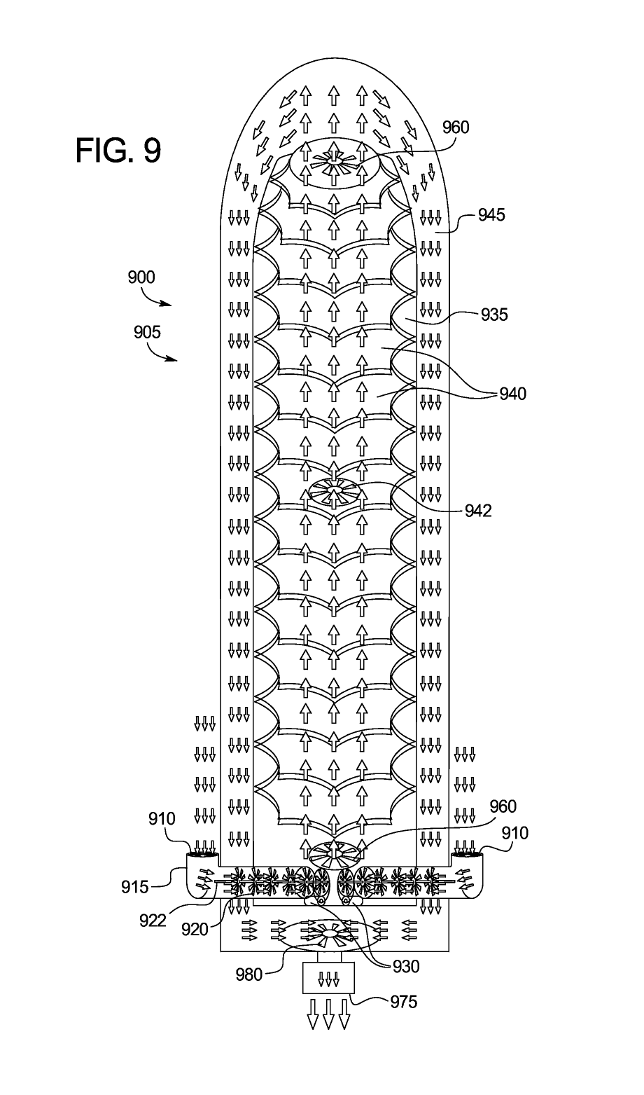

FIG. 9 illustrates another example of a rocket 900 using an example of a generator 905 as the vehicle power plant. Electric motor fans 910 pull air into rear wind tunnels 915. The rear wind tunnels 915 may be turbine pipes 115. The air flowing through the rear wind tunnels 915 turns fan blades 920. The fan blades 920 are mounted on main shafts 922 in the rear wind tunnel 915. The fan blades 920 turn the main shafts 922 that, in turn, drive electric generators 930.

A primary electric fan 960 then draws the air out of the rear wind tunnel 915 and into a primary wind tunnel 935. The primary wind tunnel 935 may include wind sails 940. An electric motor fan 942 in the middle of the primary wind tunnel 935 may further accelerate the airflow across the wind sails 940. As the air passes over the wind sails 940, it may impart forward energy to the wind sails 940 to create thrust before passing into exhaust wind tunnels 945. The exhaust wind tunnels 945 may be turbine pipes 115. The exhaust wind tunnels 945 may wrap around the interior of the rocket 900 to funnel the air out of the rear exhausts 975 at the base of the rocket 900. Air may be forced out a rear exhaust 975 by a rear exhaust fan 980.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A generator comprising:
a housing defining a chamber;
a fan in fluid communication with the chamber, wherein the fan is oriented such that operation of the fan draws a partial vacuum in the chamber;
a pipe including a first opening and a second opening, wherein the first opening is in fluid communication with the chamber and the second opening is in fluid communication with the ambient atmosphere, such that when a partial vacuum is drawn in the chamber a partial vacuum is drawn within the pipe;
a plurality of turbine blades within the pipe configured such that airflow from the second opening towards the first opening flows across the plurality of turbine blades to cause the turbine blades to rotate;
a rotating element driven into rotational movement by the rotation of the turbine blades; and
an electro-magnetic generator configured such that the rotating pipe is a rotating element within the electro-magnetic generator.

2. The generator of claim 1 wherein the housing is a portion of the pipe.

3. The generator of claim 2 wherein the housing is a hollow interior within the pipe.

4. The generator of claim 1 wherein the rotating element is the pipe.

5. The generator of claim 4 wherein the rotating pipe is magnetic.

6. The generator of claim 4 wherein the rotating pipe includes channels along an internal surface.

7. The generator of claim 6 wherein the channels along the internal surface are spiral shaped.

8. The generator of claim 1 wherein the rotating element is a shaft supporting the turbine blades.

9. The generator of claim 1 wherein the fan is a high velocity fan.

10. The generator of claim 1 wherein the fan is a jet engine.

11. The generator of claim 1 wherein the chamber includes a plurality of sails.

12. The generator of claim 11 wherein the generator is included within a vehicle power plant.

13. The generator of claim 1 wherein the generator is included within a vehicle power plant.

14. The generator of claim 1 wherein the generator includes a second fan in fluid communication with the chamber.

15. The generator of claim 14 wherein the second fan is located within a bypass tube such that airflow in the pipe flows both through the bypass tube and around the bypass tube.
